(19) United States
(12) Patent Application Publication
(10) Pub. No.: US 2026/0161063 A1
(43) Pub. Date: Jun. 11, 2026

(54) LIGHT GUIDE, OPTICAL MODULE, AND PROJECTOR

(71) Applicant: SEIKO EPSON CORPORATION, Tokyo (JP)

(72) Inventor: Yutaka AMANO, MATSUMOTO-SHI (JP)

(21) Appl. No.: 19/411,977

(22) Filed: Dec. 8, 2025

(30) Foreign Application Priority Data
Dec. 9, 2024 (JP) 2024-214611

(51) Int. Cl. G03B 21/20; G03B 21/00

(52) U.S. Cl. CPC G03B 21/2013; G03B 21/006; G03B 21/208

(57) ABSTRACT

A light guide according to an aspect of the present disclosure includes multiple plate members configured to define a light guide path configured to guide light incident via a light incident end and output the light via a light exiting end; and an adhesive configured to bond the multiple plate members to each other around the light guide path. The multiple plate members include a first member having a first reflection surface and a second member having a second reflection surface, and an area where the adhesive is in contact with the first member and the second member is greater in a region of the light guide path from an intermediate portion to the light exiting end than in a region of the light guide path from the intermediate portion to the light incident end.

The present application is based on, and claims priority from JP Application Serial Number 2024-214611, filed Dec. 9, 2024, the disclosure of which is hereby incorporated by reference herein in its entirety.

### BACKGROUND

### 1. Technical Field

The present disclosure relates to a light guide, an optical module, and a projector.

### 2. Related Art

There is a known projector of related art including a light source that outputs light, a light modulator that modulates the light output from the light source in accordance with image information to generate image light, and a projection system that enlarges the image light output from the light modulator and projects the enlarged image light onto a projection receiving surface such as a screen.

JP-A-2000-180962 discloses a projector including an LED light source that emits light, a block-shaped light guide that outputs the light emitted from the LED light source via a light exiting end of the light guide in a way that the output light has uniform brightness, a condenser lens that brings the light output from the light guide into focus to form a light source image at the entrance pupil position of a projection lens, a light modulating element that generates image light, and the projection lens.

JP-A-2000-180962 is an example of the related art.

In the projector described above, however, it is difficult to completely capture the light emitted from the LED light source into the light guide, and some light undesirably travels outside the light guide as leakage light via the gap between the light source and the light guide. For example, in the projector described above, it is also conceivable to replace the block-shaped light guide with a rectangular reflector configured with four mirrors bonded to each other with an adhesive. When such a rectangular reflector is employed in a high-luminance projector, the amount of leakage light that enters the adhesive increases, and there is a concern that the bonding reliability of the adhesive deteriorates.

### SUMMARY

A light guide according to an aspect of the present disclosure includes multiple plate members configured to define a light guide path configured to guide light incident via a light incident end and output the light via a light exiting end; and an adhesive configured to bond the multiple plate members to each other around the light guide path. The multiple plate members include a first member having a first reflection surface and a second member having a second reflection surface, and an area where the adhesive is in contact with the first member and the second member is greater in a region of the light guide path from an intermediate portion to the light exiting end than in a region of the light guide path from the intermediate portion to the light incident end.

An optical module according to another aspect of the present disclosure includes the light guide according to the aspect of the present disclosure; a first light source configured to output first light having a first wavelength band toward the light incident end of the light guide path in the light guide; a first parallelizing element configured to parallelize the first light output via the light exiting end of the light guide path; and a first light modulator configured to modulate the first light output from the first parallelizing element based on image information.

A projector according to another aspect of the present disclosure includes: a first image forming module including a first light guide configured with the light guide according to the aspect of the present disclosure, a first light source configured to output first light having a first wavelength band toward the first light guide, a first parallelizing element configured to parallelize the first light output from the first light guide, and a first light modulator configured to modulate the first light output from the first parallelizing element based on image information; a second image forming module including a second light guide configured with the light guide according to the aspect of the present disclosure, a second light source configured to output second light having a second wavelength band different from the first wavelength band toward the second light guide, a second parallelizing element configured to parallelize the second light output from the second light guide, and a second light modulator configured to modulate the second light output from the second parallelizing element based on image information; a third image forming module including a third light guide configured with the light guide according to the aspect of the present disclosure, a third light source configured to output third light having a third wavelength band different from the first wavelength band and the second wavelength band toward the third light guide, a third parallelizing element configured to parallelize the third light output from the third light guide, and a third light modulator configured to modulate the third light output from the third parallelizing element based on image information; a light combiner configured to combine light output from the first image forming module, light output from the second image forming module, and light output from the third image forming module with one another; and a projection system configured to project light output from the light combiner.

A projector according to another aspect of the present disclosure includes a first image forming module according to the aspect of the present disclosure; a second image forming module; a third image forming module; a light combiner; and a projection system. The second image forming module includes a second light source configured to output second light having a second wavelength band different from the first wavelength band, a light homogenizer configured to receive the second light output from the second light source and homogenize in-plane illuminance of the second light, a second parallelizing element configured to parallelize the second light output from the light homogenizer, and a second light modulator configured to modulate the second light output from the second parallelizing element based on image information. The third image forming module includes a third light source configured to output third light having a third wavelength band different from the first wavelength band and the second wavelength band, and a third light modulator configured to modulate the third light output from the third light source based on image information. The light combiner is configured to combine light output from the first image forming module, light output from the second image forming module, and light output from the third image forming module with one another and output the combined light. The projection system is configured to project the light output from the light combiner.

### BRIEF DESCRIPTION OF THE DRAWINGS

FIG. 1 is a plan view showing a schematic configuration of a projector according to an embodiment.

FIG. 2 is a perspective view of a light guide.

FIG. 3 is a plan view showing a peripheral configuration of the light guide.

FIG. 4 is a cross-sectional view of the light guide taken along the line IV-IV in FIG. 3.

FIG. 5 is a diagrammatic view illustrating the behavior of leakage light.

### DESCRIPTION OF EMBODIMENTS

An embodiment of the present disclosure will be described below with reference to the drawings.

A projector according to the present embodiment is an example of a liquid crystal projector using liquid crystal panels as light modulators.

In the following drawings, elements may be drawn at different dimensional scales for clarity of the elements.

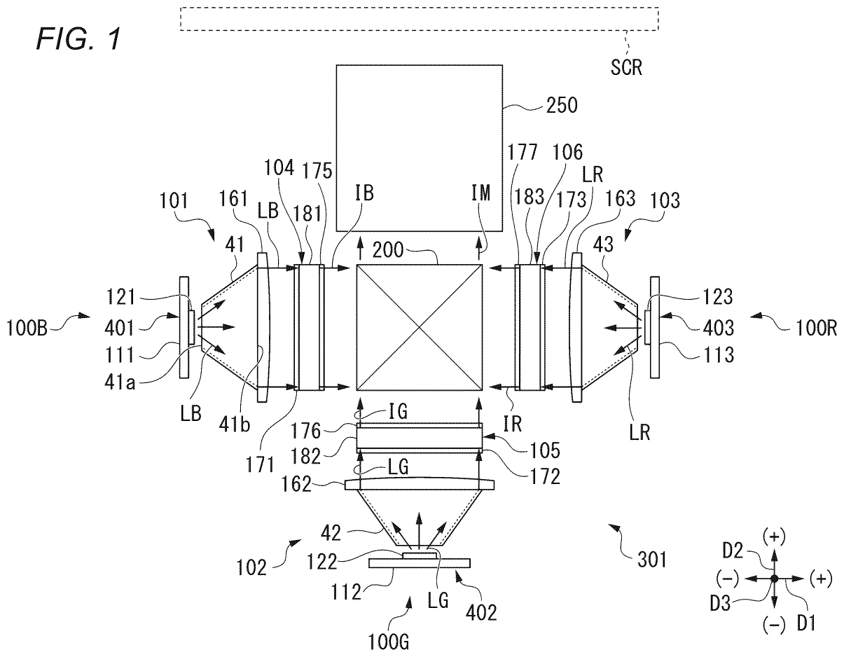

FIG. 1 is a plan view showing a schematic configuration of the projector according to the embodiment.

A projector 301 is an image display apparatus including three liquid crystal panels as the light modulators, and is what is called a three-plate projector, as shown in FIG. 1. The projector 301 includes a first image forming module 100B, a second image forming module 100G, a third image forming module 100R, a light combiner 200, and a projection system 250.

The first image forming module 100B includes a blue light output portion 101 and a blue light modulator (first light modulator) 104. The second image forming module 100G includes a green light output portion 102 and a green light modulator (second light modulator) 105. The third image forming module 100R includes a red light output portion 103 and a red light modulator (third light modulator) 106.

The first image forming module 100B will first be described. The blue light output portion 101 of the first image forming module 100B outputs blue light LB. In the following description, a direction parallel to the optical axis of the blue light LB output from the blue light output portion 101 is referred to as a D1 direction. One side in the D1 direction is referred to as a −D1 side, and the side opposite the −D1 side in the D1 direction is referred to as a +D1 side. The direction perpendicular to the D1 direction in a plane containing the optical axis of the blue light LB is referred to as a D2 direction. One side in the D2 direction is referred to as a −D2 side, and the side opposite the −D2 side in the D2 direction is referred to as a +D2 side. The direction perpendicular to the D1 and D2 directions is referred to as a D3 direction. The blue light LB output from the blue light output portion 101 travels toward the +D1 side along the D1 direction.

The blue light output portion 101 includes a first light source 401, a first light guide 41, and a first parallelizing element 161. A first light emitter 121 of the first light source 401 is supported by a first substrate 111. The first substrate 111 is a plate parallel to a plane containing the D2 and D3 directions.

The first light emitter 121 is provided at the +D1-side plate surface of the first substrate 111. The light emitting surface of the first light emitter 121 is the +D1-side surface opposite the surface thereof facing the first substrate 111. The first light emitter 121 emits the blue light LB having a blue wavelength band in the visible wavelength band. The blue wavelength band corresponds to a first wavelength band. The blue light LB corresponds to first light. The blue light LB is emitted toward the +D1 side and has a center axis passing through the center of the light emitting surface of the first light emitter 121 and parallel to the D1 direction. The blue wavelength band is, for example, a wavelength band ranging from 420 nm to 500 nm. The blue wavelength band is the shortest wavelength band out of three types of color light used by the three-plate projector, and therefore has high energy.

The first light emitter 121 is configured, for example, with an LED that emits the blue light LB. Note that the first light emitter 121 may be configured with one LED or multiple LEDs in their entirety. When the first light emitter 121 is configured with multiple LEDs, the multiple LEDs are arranged in the region occupied by the first light emitter 121 in the plane containing the D2 and D3 directions.

The first light guide 41 is provided in the optical path of the blue light LB output from the first light source 401, and is disposed on the +D1 side of the first light emitter 121 of the first light source 401 at a position where the first light guide 41 overlaps with the first light emitter 121 in the D2 and D3 directions. The first light guide 41 will be described later in detail.

The first parallelizing element 161 is provided in the optical path of the blue light LB output from the first light guide 41. The first parallelizing element 161 parallelizes along the D1 direction the blue light LB output from the first light guide 41.

The blue light modulator 104 includes a first light-incident-side polarizer 171, a first light modulating element 181, and a first light-exiting-side polarizer 175. The blue light modulator 104 is provided in the optical path of the blue light LB output from the first parallelizing element 161.

The first light-incident-side polarizer 171 is disposed on the +D1 side of the first parallelizing element 161. The first light-incident-side polarizer 171 outputs predetermined polarized light toward the +D1 side along the D1 direction out of the blue light LB output from the first parallelizing element 161. The first light-incident-side polarizer 171 is, for example, a reflective or absorptive polarizer plate.

The first light modulating element 181 is disposed on the +D1 side of the first light-incident-side polarizer 171. The first light modulating element 181 modulates the blue light LB output from the first light-incident-side polarizer 171. The first light modulating element 181 is, for example, a transmissive liquid crystal panel. The liquid crystal panel that constitutes the first light modulating element 181 generates blue image light IB by modulating light based on blue image information. The first light modulating element 181 outputs the generated image light IB toward the +D1 side along the D1 direction.

The first light-exiting-side polarizer 175 is disposed on the +D1 side of the first light modulating element 181. The first light-exiting-side polarizer 175 outputs predetermined polarized light toward the +D1 side along the D1 direction out of the image light IB output from the first light modulating element 181. The first light-exiting-side polarizer 175 is, for example, a reflective or absorptive polarizer plate.

The configuration of the first light guide 41 will next be described.

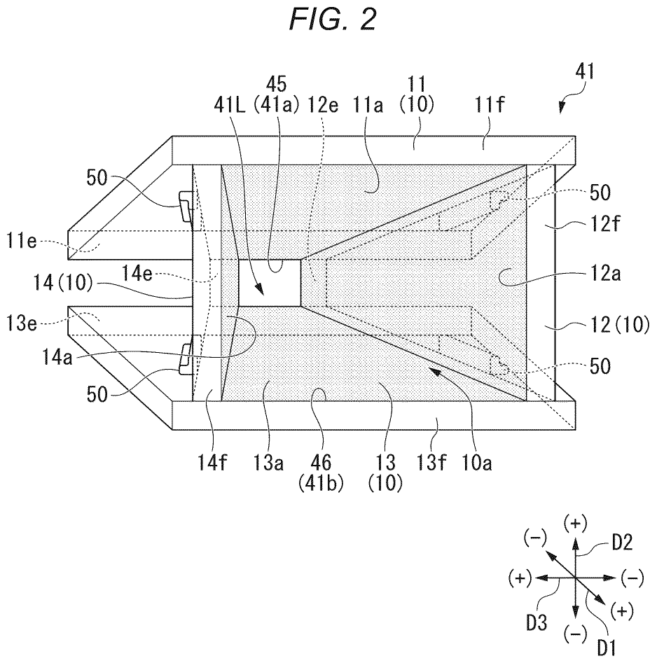

FIG. 2 is a perspective view of the first light guide 41. The first light guide 41 defines a light guide path that guides the blue light LB emitted from the first light emitter 121, and causes the blue light LB to propagate to the first light modulating element 181, as shown in FIG. 2. The first light guide 41 is configured with multiple plate members 10 made of a transparent material. The multiple plate members 10 include a first member 11, a second member 12, a third member 13, and a fourth member 14.

The first member 11 and the third member 13 are a pair of rectangular plate members. The first member 11 has one surface that is a first reflection surface 11a. The third member 13 has one surface that is a third reflection surface 13a. The first member 11 and the third member 13 are plate members having the same shape.

The second member 12 and the fourth member 14 are a pair of trapezoidal plate members. The second member 12 has one surface that is a second reflection surface 12a. The fourth member 14 has one surface that is a fourth reflection surface 14a. The second member 12 and the fourth member 14 are plate members having the same shape. In the following description, when the first reflection surface 11a, the second reflection surface 12a, the third reflection surface 13a, and the fourth reflection surface 14a are not particularly distinguished from each other, the four reflection surfaces may be collectively referred to as reflection surfaces 10a. The reflection surfaces 10a form a light guide path 41L, which guides the blue light LB to the interior of the first light guide 41.

The first light guide 41 can thus be readily produced by using the four plate members. Since the first light guide 41 is configured with the rectangular plate members, the number of times the plate members are processed can be reduced. Furthermore, since the plate members each have a simple shape, the assembly thereof is readily performed.

The first reflection surface 11a of the first member 11 and the third reflection surface 13a of the third member 13 are disposed to face each other. The second reflection surface 12a of the second member 12 and the fourth reflection surface 14a of the fourth member 14 are disposed to face each other. The second member 12 and the fourth member 14 are each so disposed that the upper base thereof is located on the −D1 side and the lower base thereof is located on the +D1 side.

One side surface that is an oblique side portion of each of the trapezoidal second member 12 and fourth member 14 is coupled to the first reflection surface 11a of the first member 11. The other side surface that is another oblique side portion of each of the second member 12 and fourth member 14 is coupled to the third reflection surface 13a of the third member 13. The multiple plate members 10 are bonded to each other with an adhesive 50, which will be described later. The shape of the first light guide 41 is thus formed by the multiple plate members 10.

The first member 11 has a −D1-side end at which a first light incident end surface 11e is provided. The second member 12 has a −D1-side end at which a second light incident end surface 12e is provided. The third member 13 has a −D1-side end at which a third light incident end surface 13e is provided. The fourth member 14 has a −D1-side end at which a fourth light incident end surface 14e is provided. A portion of the first light incident end surface 11e, the second light incident end surface 12e, a portion of the third light incident end surface 13e, and the fourth light incident end surface 14e form a light incident opening 45. The light incident opening 45 forms a light incident end 41a of the light guide path 41L.

The first member 11 has a +D1-side end at which a first light exiting end surface 11f is provided. The second member 12 has a +D1-side end at which a second light exiting end surface 12f is provided. The third member 13 has a +D1-side end at which a third light exiting end surface 13f is provided. The fourth member 14 has a +D1-side end at which a fourth light exiting end surface 14f is provided. The first light exiting end surface 11f, the second light exiting end surface 12f, the third light exiting end surface 13f, and the fourth light exiting end surface 14f form a light exiting opening 46. The light exiting opening 46 forms a light exiting end 41b of the light guide path 41L.

The light incident opening 45 spreads in parallel to the plane containing the D2 and D3 directions. The shape of the light incident opening 45 viewed in the D1 direction is the same as the shape of the light emitting surface of the first light emitter 121 viewed in the same direction, and is a rectangular shape. The size of the light incident opening 45 may be comparable to the size of the light emitting surface of the first light emitter 121, but it is preferable that the light incident opening 45 is appropriately larger than the light emitting surface of the first light emitter 121.

The light exiting opening 46 spreads in parallel to the plane containing the D2 and D3 directions. The light exiting opening 46 is larger than the light incident opening 45. The light exiting opening 46 when viewed in the D1 direction has a rectangular shape. The size of the light exiting end 41b is comparable to the size of the first light modulating element 181.

The configuration described above can increase the luminous flux width of the blue light LB incident via the light incident opening 45 in the process of causing the blue light LB to propagate in the light guide path. Blue light LB which has a uniform illuminance distribution and with which the entire first light modulating element 181 is efficiently illuminated can thus be generated.

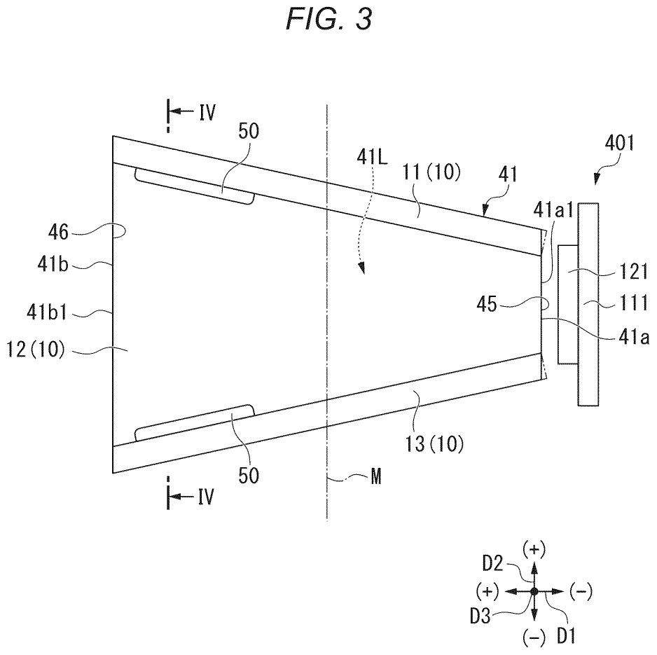

FIG. 3 is a plan view showing a peripheral configuration of the light guide. The light guide path 41L of the first light guide 41 has the light incident end 41a and the light exiting end 41b, as shown in FIG. 3. The light incident end 41a is located on the −D1 side in the D1 direction. The light exiting end 41b is located on the +D1 side in the D1 direction.

The first light incident end surface 11e and the third light incident end surface 13e are parallel to the plane containing the D2 and D3 directions. When normal plate members are bonded as they are with each other, the corners of the first light incident end surface 11e of the first member 11 and the third light incident end surface 13e of the third member 13 protrude toward the −D1 side, as indicated by the dotted lines in FIG. 3. In the present embodiment, the corners of the first light incident end surface 11e and the third light incident end surface 13e are cut off so as to be parallel to the plane containing the D2 and D3 directions. Similarly, the second light incident end surface 12e and the fourth light incident end surface 14e are parallel to the plane containing the D2 and D3 directions. The “plane containing the D2 and D3 directions” in the present embodiment corresponds to the “plane perpendicular to an optical axis of the light guide path” in the claims.

According to the configuration described above, the gap between the light incident opening 45 and the first light source 401 in the D1 direction can be reduced. The light incident opening 45 and the first light source 401 can therefore be disposed close to each other in the D1 direction. The amount of leakage light LL generated while traveling from the first light source 401 toward the light incident opening 45 of the first light guide 41 can therefore be suppressed.

In the present embodiment, the first light exiting end surface 11f and the third light exiting end surface 13f are parallel to the plane containing the D2 and D3 directions. Similarly, the second light exiting end surface 12f and the fourth light exiting end surface 14f are parallel to the plane containing the D2 and D3 directions. The corners of the first light incident end surface 11e and the third light incident end surface 13e may be cut off so as to be parallel to the plane containing the D2 and D3 directions.

According to the configuration described above, the gap between the light exiting opening 46 and the first light modulating element 181 can be reduced. The light exiting opening 46 and the first light modulating element 181 can therefore be disposed close to each other. The amount of the leakage light LL generated while traveling from the light exiting opening 46 of the first light guide 41 toward the first light modulating element 181 can therefore be suppressed.

The blue light LB output from the first light source 401 enters the light guide path 41L of the first light guide 41 via the light incident end 41a. In the first light guide 41, the space surrounded by the light incident opening 45, the light exiting opening 46, and the reflection surfaces 10a forms the light guide path 41L, through which the blue light LB propagates. The blue light LB that enters the first light guide 41 propagates through the light guide path 41L from the −D1 side toward the +D1 side, as described above.

Part of the blue light LB having entered the first light guide 41 propagates directly from the light incident end 41a to the light exiting end 41b, without being incident on the reflection surfaces 10a even once, along directions inclining by angles smaller than the inclination angle of the oblique sides of the trapezoidal second member 12 and fourth member 14. The remaining part of the blue light LB having entered the first light guide 41 inclines by angles greater than or equal to the angles described above, is incident on the reflection surfaces 10a via the light incident end 41a once or a greater number of times, is reflected off the reflection surfaces 10a, and then reaches the light exiting end 41b. The paths of beams that constitute the blue light LB in the region surrounded by the light incident end 41a, the light exiting end 41b, and the reflection surfaces 10a vary in accordance with the angles of incidence of the beams incident on the light incident end 41a, and there are multiple paths along which the beams are reflected off the reflection surfaces 10a by different numbers of times. The illuminance distribution of the blue light LB that propagates through the region surrounded by the light incident end 41a, the light exiting end 41b, and the reflection surfaces 10a is therefore homogenized in the planes containing the D2 and D3 directions. That is, the first light guide 41 homogenizes the illuminance distribution of the incident blue light LB in the planes containing the D2 and D3 directions. The blue light LB having the homogenized illuminance distribution exits via the light exiting end 41b toward the +D1 side.

The adhesive 50, which bonds the multiple plate members 10 to each other, will next be described. The adhesive 50 bonds the multiple plate members 10 to each other to form the first light guide 41, which surrounds the light guide path 41L. The adhesive 50 is provided along portions of the oblique sides of the trapezoid second member 12 and fourth member 14. The adhesive 50 is provided as a whole on a side of an intermediate portion M of the light guide path 41L in the lengthwise direction thereof (D1 direction) that is the side facing the light exiting end 41b. The intermediate portion M of the light guide path 41L means a portion located at an equal distance in the D1 direction from the light incident end 41a and the light exiting end 41b.

In the present embodiment, the adhesive 50 is provided at positions separate from the light incident end 41a by about ¾ of the length from the light incident end 41a to the light exiting end 41b. Note that a portion of the adhesive 50 may be provided at a region beyond the intermediate portion M toward the light incident end 41a.

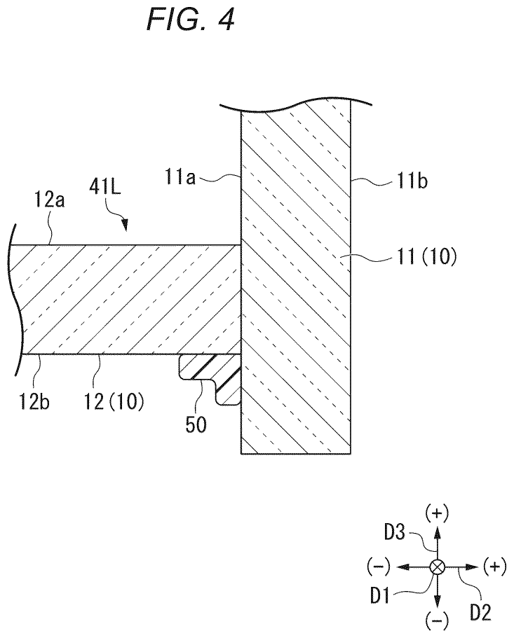

The area where the adhesive 50 is in contact with the multiple plate members 10 is greater in a region of the light guide path that is the region from the intermediate portion M to the light exiting end 41b than in a region of the light guide path that is the region from the intermediate portion M to the light incident end 41a. The contact area will be described more specifically with reference to FIG. 4.

FIG. 4 is a cross-sectional view of the first light guide 41 taken along the line IV-IV in FIG. 3. FIG. 4 only shows for clarity that the adhesive 50 bonds the first member 11 and the second member 12 to each other. The adhesive 50 is located outside the light guide path defined by the first light guide 41, as shown in FIGS. 3 and 4.

The first member 11 and the second member 12 are so disposed that one side surface that is an oblique side portion of the second member 12 is in contact with a portion of the first reflection surface 11a of the first member 11. The adhesive 50 bonds a portion of the first reflection surface 11a that is a portion outside the light guide path 41L to an outer surface 11b of the second member 12 that is the surface opposite the second reflection surface 12a. The area where the adhesive 50 is in contact with the first member 11 and the second member 12 is therefore greater in a region of the light guide path 41L that is the region from the intermediate portion M to the light exiting end 41b than in a region of the light guide path 41L that is the region from the intermediate portion M to the light incident end 41a. The first member 11 and the second member 12 are thus bonded to each other via the adhesive 50. Similarly, the second member 12 and the third member 13, the third member 13 and the fourth member 14, and the fourth member and the first member 11 are bonded to each other via the adhesive 50.

Note that the adhesive 50 may not be provided in the form of a single block along portions of the oblique sides of the trapezoidal second member 12 and fourth member 14, and may be provided in the form of multiple discontinuous blocks. The contact area in the present embodiment is not only a continuous contact area, but also the sum of discontinuous contact areas.

The adhesive 50 may be an adhesive of any type, such as an ultraviolet curing type, a natural curing type, or a thermosetting type. The adhesive 50 may be appropriately changed as long as the adhesive 50 can bond the multiple plate members 10 to each other to form the shape of the first light guide 41.

In the thus configured first light guide 41, even when the light incident opening 45 and the first light source 401 are brought close to each other, part of the blue light LB leaks to the exterior of the light guide path 41L and becomes the leakage light LL in some cases. The leakage light LL is generated while traveling from the first light source 401 toward the light incident opening 45 of the first light guide 41 and leaks to the exterior of the light guide path 41L.

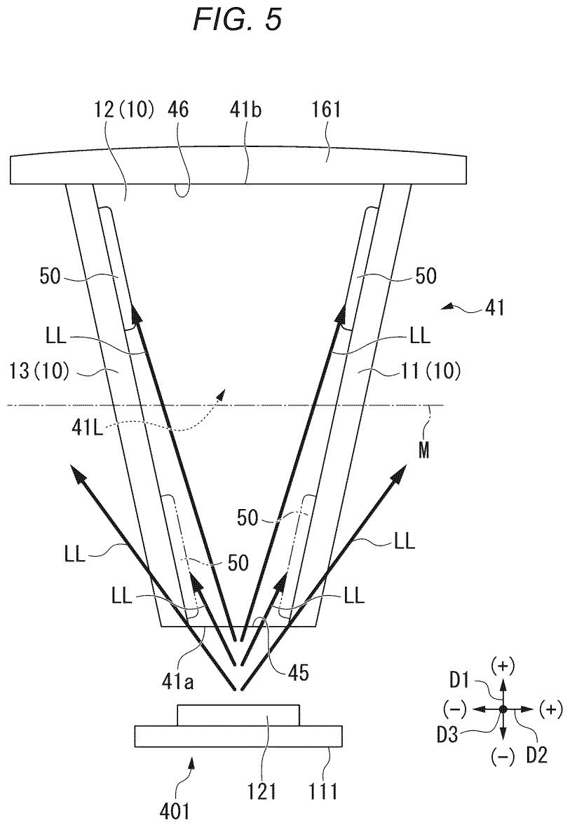

The behavior of the leakage light LL will now be described. FIG. 5 is a diagrammatic view illustrating the behavior of the leakage light LL. The leakage light LL is light output from the first light source 401 along directions inclining by angles greater than the taper angle of the trapezoidal second member 12 and fourth member 14, as shown in FIG. 5. The leakage light LL contains various angular components, and the leakage light LL output along directions inclining by angles slightly greater than the taper angle of the trapezoidal second member 12 and fourth member 14 is likely to be incident on a side surface of the first light guide 41 that is the side surface facing the light incident end 41a.

To allow the leakage light LL to reach a side surface of the first light guide 41 that is the side surface facing the light exiting end 41b, the leakage light LL output in a direction inclining by an angle comparable to the taper angle of the trapezoid second member 12 and fourth member 14 needs to travel along the outer surface of the first light guide 41 from the light incident end 41a to the light exiting end 41b. The amount of the leakage light LL that reaches the light exiting end 41b is therefore greatly smaller than the amount of the leakage light LL incident on the light incident end 41a.

Therefore, when the adhesive 50 is provided on the side facing the light incident end 41a, the adhesive 50 is likely to deteriorate due to an increase in the amount of the leakage light LL with which the adhesive 50 is irradiated.

In contrast, in the first light guide 41 according to the present embodiment, since the adhesive 50 is provided on the side facing the light exiting end 41b rather than the side facing the light incident end 41a, the leakage light LL that leaks to the exterior of the light incident opening 45 of the first light guide 41 is unlikely to hit the adhesive 50, so that deterioration of the adhesive 50 can be suppressed. A decrease in bonding strength of the adhesive 50, which bonds the multiple plate members 10 to each other, can therefore be suppressed.

As described above, the first light guide 41 according to the present embodiment includes the multiple plate members 10, which define the light guide path having the light incident end 41a and the light exiting end 41b and guiding light, and the adhesive 50, which bonds the multiple plate members 10 to each other around the light guide path 41L, the multiple plate members 10 include the first member 11 having the first reflection surface 11a and the second member 12 having the second reflection surface 12a, and the area where the adhesive 50 is in contact with the first member 11 and the second member 12 is greater in a region of the light guide path that is the region from the intermediate portion M to the light exiting end 41b than in a region of the light guide path that is the portion from the intermediate portion M to the light incident end 41a.

In the first light guide 41 according to the present embodiment, since the adhesive 50 is provided on the side facing the light exiting end 41b rather than the side facing the light incident end 41a, the leakage light LL that leaks to the exterior of the light incident opening 45 of the first light guide 41 is unlikely to hit the adhesive 50, so that deterioration of the adhesive 50 can be suppressed. A decrease in bonding strength of the adhesive 50, which bonds the multiple plate members 10 to each other, can therefore be suppressed.

Furthermore, as compared with a case where the multiple plate members 10 each have a trapezoidal shape, the surface where the adhesive 50 bonds the multiple plate members 10 to each other can be widened, so that the adhesive 50 can be readily applied, and the multiple plate members 10 can be readily assembled.

As described above, the first image forming module 100B in the present embodiment includes the first light guide 41, the first light source 401, the first parallelizing element 161, and the first light modulator 104.

The first image forming module 100B in the present embodiment, which includes the first light guide 41, can provide a highly reliable optical module in which a decrease in the bonding strength of the adhesive 50, which bonds the multiple plate members 10 to each other, is suppressed.

The second image forming module 100G will next be described. The green light output portion 102 of the second image forming module 100G is disposed on the +D1 side and the −D2 side of the blue light output portion 101 in a region where the green light output portion 102 overlaps with the blue light output portion 101 in the D3 direction. The green light output portion 102 outputs green light LG. The green light LG output from the green light output portion 102 travels toward the +D2 side along the D2 direction.

The green light output portion 102 includes a second light source 402, a second light guide 42, and a second parallelizing element 162. A second light emitter 122 of the second light source 402 is supported by a second substrate 112. The second substrate 112 is a plate parallel to a plane containing the D1 direction and the D3 direction.

The second light emitter 122 is provided at the +D2 side plate surface of the second substrate 112. The light emitting surface of the second light emitter 122 is the +D2-side surface opposite the surface thereof facing the second substrate 112. The second light emitter 122 emits the green light LG having a green wavelength band in the visible wavelength band. The green wavelength band corresponds to a second wavelength band. The green light LG corresponds to second light. The green light LG is emitted toward the +D2 side and has a center axis passing through the center of the light emitting surface of the second light emitter 122 and parallel to the D2 direction. The green wavelength band is, for example, a wavelength band ranging from 500 nm to 600 nm. Since the green wavelength band is likely to be recognized by human eyes, a large amount of light is required for projection onto a screen SCR. The second light emitter 122 is configured, for example, with an LED that emits the green light LG, as the first light emitter 121.

The second light guide 42 is provided in the optical path of the green light LG output from the second light source 402. The configuration of the second light guide 42 is the same as that of the first light guide 41, and has a light guide path that guides the green light LG.

The second parallelizing element 162 parallelizes along the D2 direction the green light LG output from the second light guide 42, as the first parallelizing element 161.

The green light modulator 105 includes a second light-incident-side polarizer 172, a second light modulating element 182, and a second light-exiting-side polarizer 176. The green light modulator 105 is provided in the optical path of the green light LG output from the second parallelizing element 162.

The second light-incident-side polarizer 172 outputs predetermined polarized light toward the +D2 side along the D2 direction out of the green light LG output from the second parallelizing element 162, as the first light-incident-side polarizer 171.

The second light modulating element 182 modulates the green light LG output from the second light-incident-side polarizer 172, as the first light modulating element 181. The second light modulating element 182 generates green image light IG based on green image information. The second light modulating element 182 outputs the image light IG toward the +D2 side along the D2 direction.

The second light-exiting-side polarizer 176 outputs predetermined polarized light toward the +D2 side along the D2 direction out of the image light IG output from the second light modulating element 182, as the first light-exiting-side polarizer 175.

As described above, the second image forming module 100G in the present embodiment includes the second light guide 42, the second light source 402, the second parallelizing element 162, and the second light modulator 105.

According to the second image forming module 100G in the present embodiment, the configuration of the second light guide 42 is the same as that of the first light guide 41. The second image forming module 100G can therefore provide a highly reliable optical module in which a decrease in the bonding strength of the adhesive 50, which bonds the multiple plate members 10 to each other, is suppressed, as the first image forming module 100B.

The third image forming module 100R will next be described. The red light output portion 103 of the third image forming module 100R is disposed on the +D1 side of the green light output portion 102 in a region where the red light output portion 103 overlaps with the blue light output portion 101 in the D2 and D3 directions. The red light output portion 103 outputs red light LR. The red light LR output from the red light output portion 103 travels toward the −D1 side along the D1 direction.

The red light output portion 103 includes a third light source 403, a third light guide 43, and a third parallelizing element 163. A third light emitter 123 of the third light source 403 is supported by a third substrate 113. The third substrate 113 is a plate parallel to the plane including the D2 and D3 directions.

The third light emitter 123 is provided at the −D1 side plate surface of the third substrate 113. The light emitting surface of the third light emitter 123 is the −D1-side surface opposite the surface thereof facing the third substrate 113. The third light emitter 123 emits the red light LR having a red wavelength band in the visible wavelength band. The red wavelength band corresponds to a third wavelength band. The red light LR corresponds to third light. The red light LR is emitted toward the −D1 side and has a center axis passing through the center of the light emitting surface of the third light emitter 123 and parallel to the D1 direction. The red wavelength band is, for example, a wavelength band ranging from 610 nm to 700 nm. The third light emitter 123 is configured, for example, with an LED that emits the red light LR, as the first light emitter 121 and the second light emitter 122.

The third light guide 43 is provided in the optical path of the red light LR output from the third light source 403. The configuration of the third light guide 43 is the same as that of the first light guide 41, and has a light guide path that guides the red light LR.

The third parallelizing element 163 parallelizes along the D1 direction the red light LR output from the third light guide 43, as the first parallelizing element 161 and the second parallelizing element 162.

The red light modulator 106 includes a third light-incident-side polarizer 173, a third light modulating element 183, and a third light-exiting-side polarizer 177. The red light modulator 106 is provided in the optical path of the red light LR output from the third parallelizing element 163.

The third light-incident-side polarizer 173 outputs predetermined polarized light toward the −D1 side along the D1 direction out of the red light LR output from the third parallelizing element 163, as the first light-incident-side polarizer 171 and the second light-incident-side polarizer 172.

The third light modulating element 183 modulates the red light LR output from the third light-incident-side polarizer 173, as the first light modulating element 181 and the second light modulating element 182. The third light modulating element 183 generates red image light IR. The third light modulating element 183 outputs the image light IR toward the −D1 side along the D1 direction.

The third light-exiting-side polarizer 177 outputs predetermined polarized light toward the −D1 side along the D1 direction out of the image light IR output from the third light modulating element 183, as the first light-exiting-side polarizer 175 and the second light-exiting-side polarizer 176.

The light combiner 200 is disposed in a region where the optical path of the blue image light IB, the optical path of the green image light IG, and the optical path of the red image light IR intersect with one another. The light combiner 200 combines the image light IB output from the first light-exiting-side polarizer 175, the image light IG output from the second light-exiting-side polarizer 176, and the image light IR output from the third light-exiting-side polarizer 177 with one another, and outputs generated image light IM toward the +D2 side along the D2 direction.

The projection system 250 is disposed in the optical path of the image light IM output from the light combiner 200. The projection system 250 enlarges images input to the first light modulating element 181, the second light modulating element 182, and the third light modulating element 183 and projects and displays the enlarged images on the screen SCR.

As described above, the third image forming module 100R in the present embodiment includes the third light guide 43, the third light source 403, the third parallelizing element 163, and the third light modulator 106.

According to the third image forming module 100R in the present embodiment, the configuration of the third light guide 43 is the same as that of the first light guide 41. The third image forming module 100R can therefore provide a highly reliable optical module in which a decrease in the bonding strength of the adhesive 50, which bonds the multiple plate members 10 to each other, is suppressed, as the first image forming module 100B.

As described above, the projector according to the present embodiment includes the first image forming module 100B including the first light guide 41, the first light source 401, the first parallelizing element 161, and the first light modulator 104, the second image forming module 100G including the second light guide 42, the second light source 402, the second parallelizing element 162, and the second light modulator 105, the third image forming module 100R including the third light guide 43, the third light source 403, the third parallelizing element 163, and the third light modulator 106, the light combiner 200, and the projection system 250.

The projector 301 according to the present embodiment, in which the image forming modules 100B, 100G, and 100R corresponding to the three colors include the light guides 41, 42, and 43 described above, can be a highly reliable projector that suppresses a decrease in the bonding strength due to radiation of the multiple types of color light to the adhesive that bonds the multiple plate members 10, which constitute the light guides 41, 42, and 43, to each other.

Note that the projector 301 according to the aforementioned embodiment has been described with reference to the case where the first image forming module 100B, the second image forming module 100G, and the third image forming module 100R are each configured with the optical module according to the present disclosure, but the projector according to an aspect of the present disclosure is not limited thereto. For example, only one of the first image forming module 100B, the second image forming module 100G, and the third image forming module 100R may be configured with the optical module according to an aspect of the present disclosure, or two of the image forming modules described above may each be configured therewith. When only one of the image forming modules is configured with the optical module according to an aspect of the present disclosure, it is preferable to configure a projector in which the first image forming module is configured with the optical module corresponding to the blue light LB or the green light LG. For example, in a projector including the first image forming module 100B described above, the second image forming module may include the second light source 402, which outputs the green light LG, a light homogenizer that homogenizes the in-plane illuminance of the green light LG in replace of the light guide according to an aspect of the present disclosure, the second parallelizing element 162, which parallelizes the green light LG output from the light homogenizer, and the green light modulator 105. The third image forming module may include the third light source 403, which outputs the red light LR, and the red light modulator 106. Note that the third image forming module may include the third parallelizing element 163, which parallelizes the red light LR, and a light homogenizer that homogenizes the in-plane illuminance of the red light LR, as the second image forming module.

When two of the image forming modules are each configured with the optical module according to an aspect of the present disclosure, it is preferable that the image forming modules for the blue light LB and green light LG are each configured with the optical module according to an aspect of the present disclosure.

A reason for the above is that the blue light LB has a short wavelength and therefore has the energy higher than the energy of the red light LR and the energy of the green light LG, so that the blue light LB is likely to cause deterioration of the bonding strength of the adhesive. Another reason is that human eyes have the highest luminous sensitivity to the green light LG, and an amount of the green light LG greater than those of the red light LR and the blue light LB is necessary to maintain a desired white balance, so that the green light LG is likely to cause deterioration of the bonding strength of the adhesive. As described above, applying the present disclosure to the light guide that guides the blue light LB or the green light LG allows more effective suppression of a decrease in the bonding strength of the adhesive 50.

Note that the present embodiment has been described with reference to the case where the multiple plate members 10 are configured with four plate members, but the multiple plate members 10 may instead be configured with two plate members. More specifically, the first member 11 and the second member 12 may be integrated into a single unit. Similarly, the third member 13 and the fourth member 14 may instead be integrated into a single unit.

The present disclosure will be summarized below as additional remarks.

### Additional Remark 1

A light guide including:
multiple plate members configured to define a light guide path configured to guide light incident via a light incident end and output the light via a light exiting end; and
an adhesive configured to bond the multiple plate members to each other around the light guide path,
wherein the multiple plate members include a first member having a first reflection surface and a second member having a second reflection surface, and
an area where the adhesive is in contact with the first member and the second member is greater in a region of the light guide path from an intermediate portion to the light exiting end than in a region of the light guide path from the intermediate portion to the light incident end.

Part of the light leaks to the region outside the light guide path and becomes leakage light in some cases. The leakage light is light output to the region outside the outer surfaces of the multiple plate members. The leakage light contains various angular components, and the leakage light output along directions away from the outer surfaces of the multiple plate members is likely to be incident on the light-incident-end-side side surface of the light guide. To allow the leakage light to reach the light-exiting-end-side side surface of the light guide, the leakage light needs to travel along the outer surfaces of the multiple plate members. The amount of the leakage light that reaches the light exiting end is therefore greatly smaller than the amount of the leakage light incident on the light incident end. Therefore, when the adhesive is provided on the side facing the light incident end, the adhesive is likely to deteriorate due to an increase in the amount of the leakage light with which the adhesive is irradiated. In contrast, in the configured light guide described above, since the adhesive is provided on the side facing the light exiting end rather than the side facing the light incident end, the leakage light that leaks to the exterior of the light incident opening of the light guide is unlikely to hit the adhesive, so that the deterioration of the adhesive can be suppressed. A decrease in the bonding strength of the adhesive, which bonds the multiple plate members to each other, can therefore be suppressed.

### Additional Remark 2

The light guide according to Additional Remark 1, wherein
the multiple plate members further include a third member having a third reflection surface and a fourth member having a fourth reflection surface, and
the light guide path is so configured that the first reflection surface of the first member and the third reflection surface of the third member face each other and the second reflection surface of the second member and the fourth reflection surface of the fourth member face each other.

According to the configuration described above, the light guide is readily produced by using the four plate members.

### Additional Remark 3

The light guide according to Additional Remark 2, wherein
the first member and the third member are configured with a pair of rectangular plate members,
the second member and the fourth member are configured with a pair of trapezoidal plate members,
the light guide path has a rectangular light incident opening located at the light incident end, and a rectangular light exiting opening located at the light exiting end, and
the light exiting opening is larger than the light incident opening.

According to the configuration described above, the light guide is configured with the rectangular plate members, the number of times the plate members are processed can be reduced. Furthermore, since the plate members each have a simple shape, the assembly thereof is readily performed.

### Additional Remark 4

The light guide according to Additional Remark 2 or 3, wherein
the first member has a first light incident end surface located at the light incident end and a first light exiting end surface located at the light exiting end,
the third member has a third light incident end surface located at the light incident end and a third light exiting end surface located at the light exiting end, and
the first light incident end surface and the third light incident end surface and/or the first light exiting end surface and the third light exiting end surface are parallel to a plane perpendicular to an optical axis of the light guide path.

According to the configuration described above, the gap between the light incident opening and the light source can be reduced. The light incident opening and the light source can therefore be disposed close to each other. The amount of the leakage light generated while traveling from the light source toward the light incident opening of the light guide can therefore be suppressed. Furthermore, the gap between the light exiting opening and the light modulating element can be reduced. The light exiting opening and the light modulating element can therefore be disposed close to each other. The amount of the leakage light generated while traveling from the light exiting opening of the light guide toward the light modulating element can therefore be suppressed.

### Additional Remark 5

An optical module including:
the light guide according to any one of Additional Remarks 1 to 4;
a first light source configured to output first light having a first wavelength band toward the light incident end of the light guide path in the light guide;
a first parallelizing element configured to parallelize the first light output via the light exiting end of the light guide path; and
a first light modulator configured to modulate the first light output from the first parallelizing element based on image information.

The thus configured optical module, which includes the light guide described above, can provide a highly reliable optical module in which a decrease in the bonding strength of the adhesive, which bonds the multiple plate members to each other, is suppressed.

### Additional Remark 6

A projector including:
a first image forming module including a first light guide configured with the light guide according to any one of Additional Remarks 1 to 4, a first light source configured to output first light having a first wavelength band toward the first light guide, a first parallelizing element configured to parallelize the first light output from the first light guide, and a first light modulator configured to modulate the first light output from the first parallelizing element based on image information;
a second image forming module including a second light guide configured with the light guide according to any one of Additional Remarks 1 to 4, a second light source configured to output second light having a second wavelength band different from the first wavelength band toward the second light guide, a second parallelizing element configured to parallelize the second light output from the second light guide, and a second light modulator configured to modulate the second light output from the second parallelizing element based on image information;
a third image forming module including a third light guide configured with the light guide according to any one of Additional Remarks 1 to 4, a third light source configured to output third light having a third wavelength band different from the first wavelength band and the second wavelength band toward the third light guide, a third parallelizing element configured to parallelize the third light output from the third light guide, and a third light modulator configured to modulate the third light output from the third parallelizing element based on image information;
a light combiner configured to combine light output from the first image forming module, light output from the second image forming module, and light output from the third image forming module with one another; and
a projection system configured to project light output from the light combiner.

The thus configured projector, in which the image forming modules corresponding to the three colors each include the light guide described above, can be a highly reliable projector that suppresses a decrease in bonding strength due to radiation of the multiple types of color light to the adhesive that bonds the multiple plate members, which constitute the light guides, to each other.

### Additional Remark 7

A projector including:
a first image forming module configured with the optical module according to Additional Remark 5;
a second image forming module;
a third image forming module;
a light combiner; and
a projection system,
wherein the second image forming module includes
a second light source configured to output second light having a second wavelength band different from the first wavelength band,
a light homogenizer configured to receive the second light output from the second light source and homogenize in-plane illuminance of the second light,
a second parallelizing element configured to parallelize the second light output from the light homogenizer, and
a second light modulator configured to modulate the second light output from the second parallelizing element based on image information,
the third image forming module includes
a third light source configured to output third light having a third wavelength band different from the first wavelength band and the second wavelength band, and
a third light modulator configured to modulate the third light output from the third light source based on image information,
the light combiner is configured to combine light output from the first image forming module, light output from the second image forming module, and light output from the third image forming module with one another and output the combined light, and
the projection system is configured to project the light output from the light combiner.

The thus configured projector can be a highly reliable projector that suppresses a decrease in the bonding strength in at least the first image forming module due to radiation of the light to the adhesive that bonds the multiple plate members, which constitute the first light guide, to each other.

### Additional Remark 8

The projector according to Additional Remark 7, wherein
the first light is blue light or green light.

The blue light has a short wavelength and therefore has the energy higher than the energy of the red light and the energy of the green light, so that the blue light is likely to cause deterioration of the bonding strength of the adhesive. In addition, human eyes have the highest luminous sensitivity to the green light, and an amount of the green light greater than those of the red light and the blue light is necessary to maintain a desired white balance, so that the green light is likely to cause deterioration of the bonding strength of the adhesive. As described above, applying the present disclosure to the light guide that guides the blue light or the green light allows more effective suppression of a decrease in the bonding strength of the adhesive.

What is claimed is:

1. A light guide comprising:
multiple plate members configured to define a light guide path configured to guide light incident via a light incident end and output the light via a light exiting end; and
an adhesive configured to bond the multiple plate members to each other around the light guide path,
wherein the multiple plate members include a first member having a first reflection surface and a second member having a second reflection surface, and
an area where the adhesive is in contact with the first member and the second member is greater in a region of the light guide path from an intermediate portion to the light exiting end than in a region of the light guide path from the intermediate portion to the light incident end.

2. The light guide according to claim 1, wherein
the multiple plate members further include a third member having a third reflection surface and a fourth member having a fourth reflection surface, and
the light guide path is so configured that the first reflection surface of the first member and the third reflection surface of the third member face each other and the second reflection surface of the second member and the fourth reflection surface of the fourth member face each other.

3. The light guide according to claim 2, wherein
the first member and the third member are configured with a pair of rectangular plate members,
the second member and the fourth member are configured with a pair of trapezoidal plate members,
the light guide path has a rectangular light incident opening located at the light incident end, and a rectangular light exiting opening located at the light exiting end, and
the light exiting opening is larger than the light incident opening.

4. The light guide according to claim 2, wherein
the first member has a first light incident end surface located at the light incident end and a first light exiting end surface located at the light exiting end,
the third member has a third light incident end surface located at the light incident end and a third light exiting end surface located at the light exiting end, and
the first light incident end surface and the third light incident end surface and/or the first light exiting end surface and the third light exiting end surface are parallel to a plane perpendicular to an optical axis of the light guide path.

5. An optical module comprising:
the light guide according to claim 1;
a first light source configured to output first light having a first wavelength band toward the light incident end of the light guide path in the light guide;
a first parallelizing element configured to parallelize the first light output via the light exiting end of the light guide path; and
a first light modulator configured to modulate the first light output from the first parallelizing element based on image information.

6. A projector comprising:
a first image forming module including a first light guide configured with the light guide according to claim 1, a first light source configured to output first light having a first wavelength band toward the first light guide, a first parallelizing element configured to parallelize the first light output from the first light guide, and a first light modulator configured to modulate the first light output from the first parallelizing element based on image information;
a second image forming module including a second light guide configured with the light guide according to claim 1, a second light source configured to output second light having a second wavelength band different from the first wavelength band toward the second light guide, a second parallelizing element configured to parallelize the second light output from the second light guide, and a second light modulator configured to modulate the second light output from the second parallelizing element based on image information;
a third image forming module including a third light guide configured with the light guide according to claim 1, a third light source configured to output third light having a third wavelength band different from the first wavelength band and the second wavelength band toward the third light guide, a third parallelizing element configured to parallelize the third light output from the third light guide, and a third light modulator configured to modulate the third light output from the third parallelizing element based on image information;
a light combiner configured to combine light output from the first image forming module, light output from the second image forming module, and light output from the third image forming module with one another; and
a projection system configured to project light output from the light combiner.

7. A projector comprising:
a first image forming module configured with the optical module according to claim 5;
a second image forming module;
a third image forming module;
a light combiner; and
a projection system,
wherein the second image forming module includes
a second light source configured to output second light having a second wavelength band different from the first wavelength band,
a light homogenizer configured to receive the second light output from the second light source and homogenize in-plane illuminance of the second light,
a second parallelizing element configured to parallelize the second light output from the light homogenizer, and
a second light modulator configured to modulate the second light output from the second parallelizing element based on image information,
the third image forming module includes
a third light source configured to output third light having a third wavelength band different from the first wavelength band and the second wavelength band, and
a third light modulator configured to modulate the third light output from the third light source based on image information,
the light combiner is configured to combine light output from the first image forming module, light output from the second image forming module, and light output from the third image forming module with one another and output the combined light, and
the projection system is configured to project the light output from the light combiner.

8. The projector according to claim 7, wherein the first light is blue light or green light.
